(19) United States
(12) Patent Application Publication
(10) Pub. No.: US 2003/0151492 A1
(43) Pub. Date: Aug. 14, 2003

(54) Interactive tamper-resistant lock, light, and associated methods

(76) Inventor: Jason Renfroe, Maitland, FL (US)

Correspondence Address: Jacqueline E. Hartt, Allen, Dyer, Doppelt, Milbrath & Gilchrist, P.A., 255 South Orange Avenue, Suite 1401, P.O. Box 3791, Orlando, FL, 32802-3791, US

(21) Appl. No.: 10/364,813

(22) Filed: Feb. 11, 2003

Related U.S. Application Data
(60) Provisional application No. 60/355,909, filed on Feb. 11, 2002.

(51) Int. Cl. G06F 7/04

(52) U.S. Cl. 340/5.3

(57) ABSTRACT

A combination lock and light includes a base having a locking aperture adjacent a top end. A locking ring is pivotally affixed at a first end adjacent the base top end, a second end insertable within the locking aperture, which houses a locking mechanism. Buttons within the base's front face communicate with a mechanism for releasing the locking mechanism when a preset correct sequence of buttons is depressed. Housed adjacent a bottom end of the base is an illumination source, and a switch is provided for activating the illumination source. Atop the base a cover is movable between a shielding and an interaction position relative to the buttons. The cover preferably comprises a decorative element. A stimulus-producing element housed within the base is adapted to produce a “positive” and a “negative” pair of stimuli, correlated with and engendered by a respective correct or incorrect entry of a button sequence.

### CROSS-REFERENCE TO RELATED APPLICATION

This application claims priority to provisional application 60/355,909, “Interactive Lock, Light, and Associated Methods,” filed Feb. 11, 2002.

### BACKGROUND OF THE INVENTION

1. Field of the Invention

The present invention relates to devices and methods for locking personal items, and, more particularly, to such devices and methods that are interactive and distinctive, and further, to such devices and methods that are attractive to children.

2. Description of Related Art

Combination locks have been in use for securing possessions, and it is known to use tumbler-type, wheel-type, and button sequence methods to release a locked bar or ring. It is also known to make such devices decorative and to employ other features or functionalities, such as with the “Hot Locks™” Sports Cars, which include a combination lock, toy car, and key chain.

Exemplary combination locks are described, for example, by Kajuch et al. (U.S. Pat. No. 6,401,501) and Miller et al. (U.S. Pat. No. 6,420,958).

### SUMMARY OF THE INVENTION

The combination lock of the present invention has audio and/or visual interactive features and, in a particular embodiment, an illumination feature. The combination lock comprises a base having a locking aperture adjacent a top end, and a bottom end. A locking mechanism is positioned within the base in communication with the locking aperture. A locking ring having a first end pivotally affixed to the base and a second end lockably insertable into the locking aperture is movable between a locked position wherein the second end is engaged with the locking mechanism and an unlocked position wherein the second end is not engaged with the locking mechanism. Means are positioned within the base for disengaging the locking mechanism.

Combination entry means are positioned on the base and are operable upon the disengaging means and adapted to transmit a signal indicative of a user-entered combination. Comparator means are also positioned within the base and are adapted to receive the signal from the combination entry means. The comparator means are for comparing the received signal with a predetermined correct combination, and for transmitting a match signal indicative of one of a correct and an incorrect combination having been entered.

At least one signal issuing means are also affixed to the base. The signal issuing means are selected from a group consisting of a visual signal issuing means, a tactile signal issuing means, and an audible signal issuing means, the signal issuing means adapted to receive the match signal and to issue a user-perceptible signal differentially commensurate therewith. That is, the signals comprise pairs of signals, a “positive” signal responsive to a match signal representative of a correct combination having been entered, and a “negative” signal responsive to a match signal representative of an incorrect combination having been entered.

It will be understood by one of skill in the art that alternate forms of releasing mechanisms may be contemplated, such as, but not intended to be limited to, a button release, and that the invention is not intended to be limited thereby.

In a particular embodiment, an illumination source is housed adjacent a bottom end of the base. Such an illumination source may comprise a source of steady illumination or a source of intermittent illumination. Also affixed to the base is a switch manipulable for activating the illumination source.

In a particular embodiment a cover is affixed atop the base. The cover is movable between a shielding position wherein the combination entry means is covered and an interaction position wherein the combination entry means is accessible and manipulable. The cover preferably comprises a decorative element representative of, for example, a creature or object, although this is not intended as a limitation. Such a creature may comprise, for example, a natural or fantastical being. Alternatively, the decorative element may comprise an object or abstract design.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIG. 1 is a front view of the combination lock with the cover in the shielding position.

FIG. 2 is a front view of the combination lock with the cover in the interaction position.

FIG. 3 is a side view of the combination lock as in FIG. 2.

FIG. 4 is a side view of an alternate embodiment of a combination lock having a flip-up cover and a light switch on the base.

FIG. 5 is a schematic diagram of the elements of the present invention.

FIG. 6 is a logic diagram for the combination lock of the present invention.

### DETAILED DESCRIPTION OF THE PREFERRED EMBODIMENTS

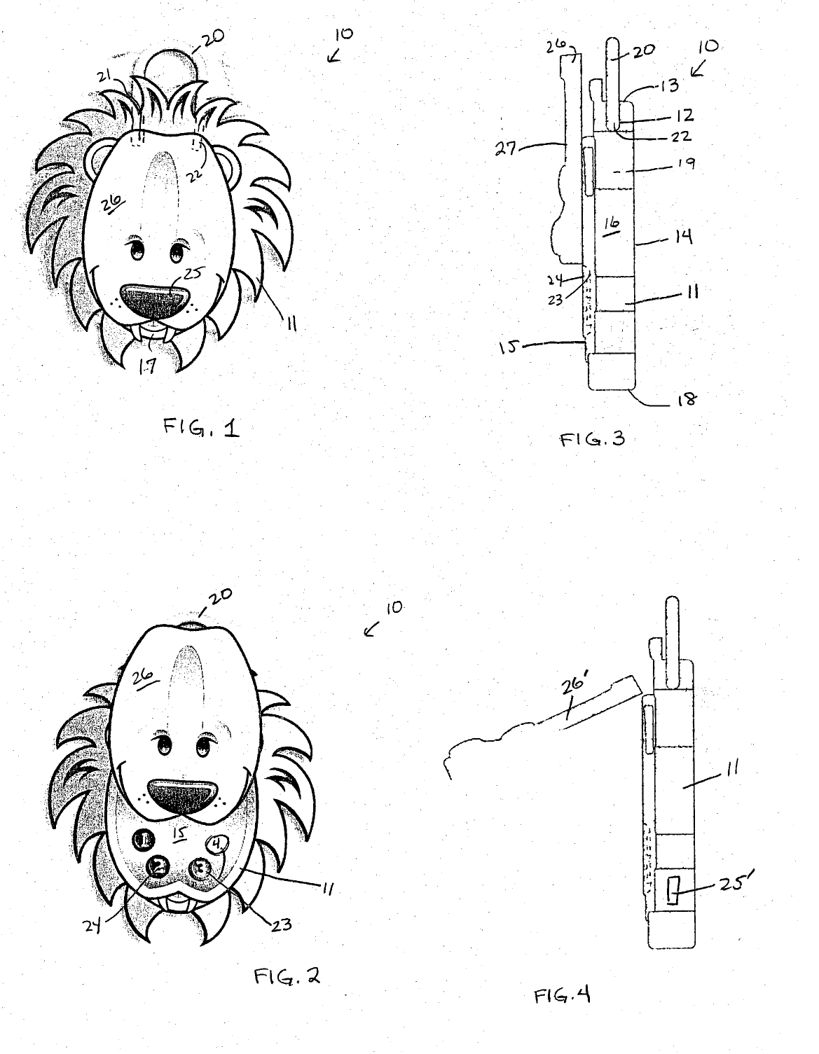

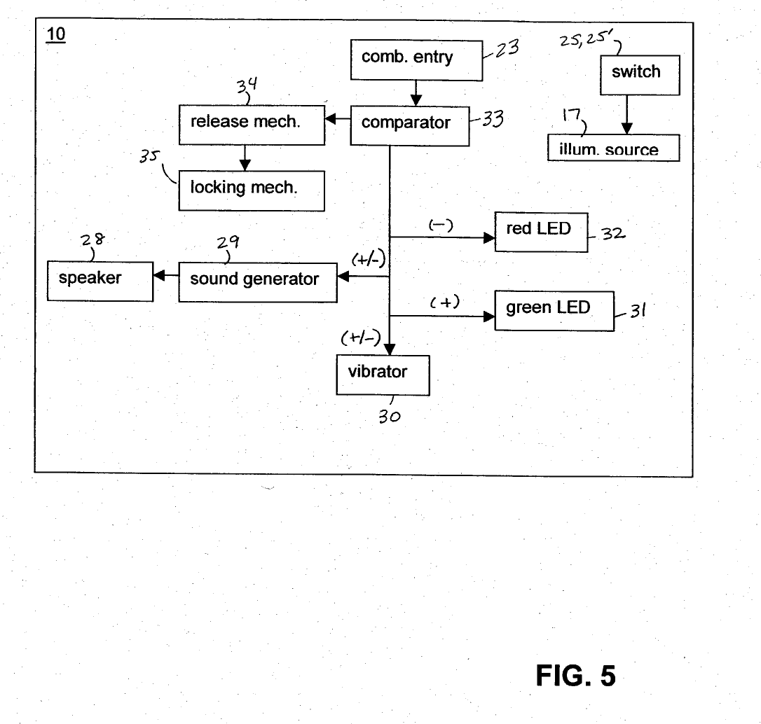

A description of the preferred embodiments of the present invention will now be presented with reference to FIGS. 1-6.

The combination lock and light device 10 comprises a base 11 having a locking aperture 12 adjacent a top end 13. The base 11 is preferably of lightweight construction, such as of molded plastic, although this is not intended as a limitation. The base 11 comprises a back face 14, a front face 15, walls 16 extending between the faces 14, 15, the top end 13, a bottom end 18, and an interior space 19.

A locking ring 20, such as an aluminum, inverted-“U”-shaped ring, is pivotally affixed at a first end 21 adjacent the base's top end 13. A second end 22 is insertable within the locking aperture 12. A locking mechanism 35 receives the second end 22 of the locking ring 20 within the locking aperture 12 in a manner such as known in the art, wherein it is locked when inserted and releasable therefrom.

A plurality of buttons 23, here four, are housed within the base's front face 15. The outer faces 24 of the buttons 23 are distinctive one from the other. For example, the buttons 23 may contain indicia 24 thereon, such as numbers, letters, or symbols, or they may comprise different colors, although these alternatives are not intended as limitations. The buttons 23 communicate with a comparator 33 that compares the entered combination with a predetermined correct combination and produces as commensurate match signal. A positive match signal is transmitted to a releasing mechanism 34 such as known in the art, housed within the base's interior space 19 and adapted to release the locking mechanism 35 when a predetermined, preset correct sequence of buttons 23 is depressed to release the second end 22 of the locking ring 20 and enable its removal from the locking aperture 12.

Housed adjacent the base's bottom end 18 is an illumination source 17, here a light bulb, which may comprise a source of steady illumination or a source of intermittent illumination. Also affixed to the device 10 is a switch 25,25′ (FIGS. 3,4) manipulable for activating the illumination source 17. The illumination source 17 may be used, for example, as a flashlight and as a safety light, such as when the device 10 is positioned on a garment, backpack, or bicycle.

Affixed atop the base 11 is a cover 26,26′ that is movable between a shielding position wherein the buttons 23 are covered and an interaction position wherein the buttons 23 are manipulable. In the embodiment of FIGS. 1-3, the cover 26 slides upward relative to the base 11; in that of FIG. 4, the cover 26′ flips upward relative to the base in pivotal fashion. The cover 26,26′ preferably comprises a decorative element representative of, for example, a creature or an object, although this is not intended as a limitation. A creature may comprise, for example, a natural or fantastical being. Alternatively, the decorative element may comprise an object or abstract design. An exemplary object may comprise, for example, a vehicle or an instrument. In a preferred embodiment the cover 26 also comprises a molded plastic.

In the embodiment shown in the figures, the creature comprises a lion, and the decorative element comprises the lion's head. Here the lion's mane is made a part of the base 11, and the lion's face appears on the cover's outer face 27. In the embodiment of FIGS. 1-3, the light switch 25 is located under the nose; in that of FIG. 4, the light switch 25′ is located on the base 11 along the wall 16.

A stimulus-producing element is also housed within the base 11 and is adapted to produce a pair of stimuli perceptible exterior of the base 11. The stimulus pair comprises a “positive” and a “negative” stimulus, correlated with and engendered by a respective correct or incorrect entry of a button sequence. The stimulus-producing element is in signal communication with the releasing mechanism for generating one of the stimulus pair depending upon the correctness or incorrectness of the button sequence entry, respectively. In the embodiment illustrated, for example, a speaker 28 in signal communication with the releasing mechanism may be housed within the base's interior space 19, along with a sound chip 29 having thereon a “purr” for a correct button sequence entry and a “roar” for an incorrect entry. In addition, a vibrator 30 may also be housed within the base's interior space 19, also in signal communication with the releasing mechanism. The vibrating stimuli then would comprise a soft vibration for a correct entry and a stronger buzz for an incorrect entry. Further, a pair of lights, such as green 31 and red 32 LEDs, are illuminated in response, respectively, to positive and negative match signals.

The various elements described above may be powered by a battery, as is known in the art. The mechanical and electronic elements may be constructed and operable by means known in the art.

The device 10 of the present invention is contemplated for use by children for locking their possessions, such as a backpack, locker, toy chest, or bicycle, although these are not intended as limitations.

It is also contemplated that the device's cover 26 may be interchangeable with others having different designs for achieving a new “look” for the user, not unlike covers known in the art for cellular telephones.

An additional feature of the present invention comprises an identification means, such as an ID tag, positioned on the device 10, such as on the back, for annotation by the user.

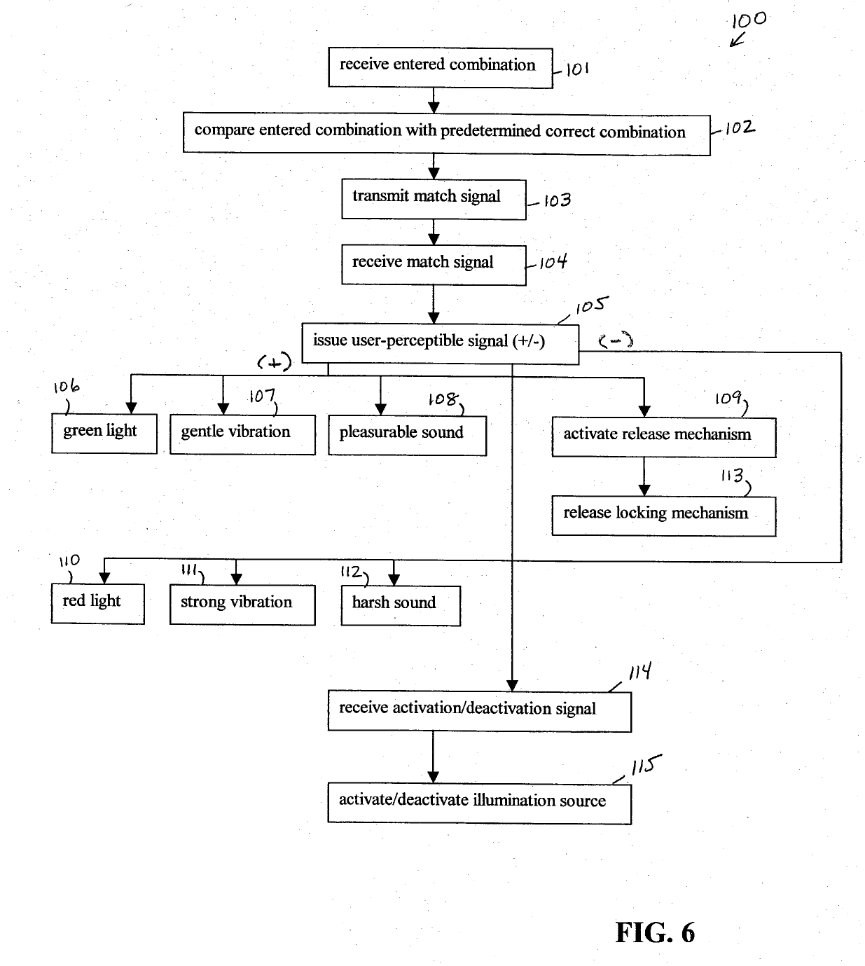

The present invention further includes a method of inhibiting a user from tampering with a combination lock (FIG. 6). The method 100 comprises the steps of receiving from the user a combination entered into a combination lock (block 101). Next the received signal is compared with a predetermined correct combination (block 102). A match signal is then transmitted that is indicative of one of a correct and an incorrect combination having been entered (block 103).

The match signal is then received (block 104) and at least one user-perceptible signal is issued (block 105). The user-perceptible signal is selected from a group consisting of a visual signal (V), a tactile signal (T), and an audible signal (A), and is differentially commensurate with the match signal (+/−). That is, if the match signal indicates that the entered combination matches the predetermined combination, a positive signal is issued (blocks 106-109); if the match signal indicates that the entered combination does not match the predetermined combination, a negative signal is issued (blocks 110-112).

For example, the visual signals may comprise a green light (block 106) or a red light (block 110); the tactile signals may comprise a gentle vibration (block 107), or a strong vibration, or “buzz” (block 111); the audible signals may comprise a pleasurable sound, such as a “purr” (block 108), or a harsh or threatening sound, such as a “roar” (block 112). Preferably the issued signals are commensurate with a creature or an object.

A positive match signal also activates the release mechanism (block 109), which in turn acts to release the locking mechanism (block 113).

The method 100 also comprising the steps of receiving from the user a signal for activating an illumination source (block 114) and activating the illumination source responsive to the received signal (block 115). The illumination source may comprise, for example, at least one of a steady illumination source and an intermittent illumination source.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction.

What is claimed is:

1. A combination lock comprising:
a base having a locking aperture adjacent a top end, and a bottom end;
a locking mechanism positioned within the base in communication with the locking aperture;
a locking ring having a first end pivotally affixed to the base and a second end lockably insertable into the locking aperture, the locking ring movable between a locked position wherein the second end is engaged with the locking mechanism and an unlocked position wherein the second end is not engaged with the locking mechanism;
means positioned within the base for disengaging the locking mechanism;
combination entry means positioned on the base operable upon the disengaging means and adapted to transmit a signal indicative of a user-entered combination;
comparator means positioned within the base adapted to receive the signal from the combination entry means, for comparing the received signal with a predetermined correct combination, and for transmitting a match signal indicative of one of a correct and an incorrect combination having been entered; and
at least one signal issuing means affixed to the base, the signal issuing means selected from a group consisting of a visual signal issuing means, a tactile signal issuing means, and an audible signal issuing means, the signal issuing means adapted to receive the match signal and to issue a user-perceptible signal differentially commensurate therewith.

2. The combination lock recited in claim 1, wherein the base has an aspect suggestive of a creature or an object and the user-perceptible signal comprises a signal commensurate with the creature or the object.

3. The combination lock recited in claim 2, wherein aspect is suggestive of an animal, the signal issuing means comprises an audible signal issuing means comprising a speaker, and the user-perceptible signal comprises a threatening sound if the match signal indicates an incorrect combination and a pleasurable sound if the match signal indicates a correct combination.

4. The combination lock recited in claim 1, wherein the signal issuing means comprises a visual signal issuing means comprising an illumination source, and the user-perceptible signal comprises a red light if the match signal indicates an incorrect combination and a green light if the match signal indicates a correct combination.

5. The combination lock recited in claim 1, wherein the signal issuing means comprises a tactile signal issuing means comprising a vibrator, and the user-perceptible signal comprises a strong vibration if the match signal indicates an incorrect combination and a gentle vibration if the match signal indicates a correct combination.

6. The combination lock recited in claim 1, further comprising an illumination source affixed to the base and a user-activatable switch affixed to the base in signal communication with the illumination source.

7. The combination lock recited in claim 6, wherein the illumination source comprises at least one of a source of steady illumination and a source of intermittent illumination.

8. The combination lock recited in claim 1, wherein the base further comprises a cover having an aspect suggestive of the creature, the cover affixed to the base movable between a shielding position in covering relation to the combination entry means and an interaction position wherein the combination entry means are accessible.

9. The combination lock recited in claim 8, wherein the cover is movable by one of a sliding motion and a pivotal motion.

10. The combination lock recited in claim 8, wherein the cover is further removable and interchangeable with another cover for altering the aspect.

11. The combination lock recited in claim 1, wherein the combination entry means comprise a plurality of mutually differentiable buttons.

12. A combination lock tamper indicator comprising:
comparator means adapted to receive a signal indicative of a user-entered combination in a combination lock, for comparing the received signal with a predetermined correct combination, and for transmitting a match signal indicative of one of a correct and an incorrect combination having been entered; and
at least one signal issuing means selected from a group consisting of a visual signal issuing means, a tactile signal issuing means, and an audible signal issuing means, the signal issuing means adapted to receive the match signal and to issue a user-perceptible signal differentially commensurate therewith.

13. The combination lock tamper indicator recited in claim 12, wherein the user-perceptible signal comprises a signal commensurate with a creature or an object.

14. The combination lock tamper indicator recited in claim 13, wherein the signal issuing means comprises an audible signal issuing means comprising a speaker, and the user-perceptible signal comprises a threatening sound if the match signal indicates an incorrect combination and a pleasurable sound if the match signal indicates a correct combination, the threatening sound and the pleasurable sound commensurate with the creature or the object.

15. The combination lock tamper indicator recited in claim 13, wherein the signal issuing means comprises a visual signal issuing means comprising an illumination source, and the user-perceptible signal comprises a red light if the if the match signal indicates an incorrect combination and a green light if the match signal indicates a correct combination.

16. The combination lock tamper indicator recited in claim 13, wherein the signal issuing means comprises a tactile signal issuing means comprising a vibrator, and the user-perceptible signal comprises a strong vibration if the if the match signal indicates an incorrect combination and a gentle vibration if the match signal indicates a correct combination.

17. A method of inhibiting a user from tampering with a combination lock comprising the steps of:
receiving from the user a combination entered into a combination lock;
comparing the received signal with a predetermined correct combination;
transmitting a match signal indicative of one of a correct and an incorrect combination having been entered;
receiving the match signal; and
issuing at least one user-perceptible signal selected from a group consisting of a visual signal, a tactile signal, and an audible signal, the user-perceptible signal differentially commensurate with the match signal.

18. The method recited in claim 17, wherein the user-perceptible signal comprises a signal commensurate with a creature or an object.

19. The method recited in claim 18, wherein signal is commensurate with a creature comprising an animal, the issuing step comprises emitting a threatening animal sound if the match signal indicates an incorrect combination and a pleasurable animal sound if the match signal indicates a correct combination.

20. The method recited in claim 18, wherein the signal issuing step comprises issuing a visual signal comprising a red light if the if the match signal indicates an incorrect combination and a green light if the match signal indicates a correct combination.

21. The method recited in claim 18, wherein the signal issuing step comprises issuing a tactile signal comprising a strong vibration if the if the match signal indicates an incorrect combination and a gentle vibration if the match signal indicates a correct combination.

22. The method recited in claim 17, further comprising the steps of:
receiving from the user a signal for activating an illumination source; and
activating the illumination source responsive to the received signal.

23. The method recited in claim 22, wherein the illumination source comprises at least one of a steady illumination source and an intermittent illumination source.
